(19) United States
(12) Patent Application Publication
(10) Pub. No.: US 2015/0281459 A1
(43) Pub. Date: Oct. 1, 2015

(54) METHOD AND SYSTEM FOR VOICEMAIL OPERATIONS MANAGEMENT

(71) Applicant: VONAGE NETWORK LLC, Holmdel, NJ (US)

(72) Inventors: Weiping Guo, Hillsborough, NJ (US); Itay Bianco, Tel-Aviv (IL); Kai Xin, East Brunswick, NJ (US); Zhiyu Guo, South River, NJ (US); Boaz Zehavi, Jersey City, NJ (US); Joseph Pagnotta, Red Bank, NJ (US)

(73) Assignee: VONAGE NETWORK LLC, Holmdel, NJ (US)

(21) Appl. No.: 14/228,755

(22) Filed: Mar. 28, 2014

(51) Int. Cl. H04M 3/533; H04M 3/428

(52) U.S. Cl. CPC H04M 3/53366; H04M 3/428

(57) ABSTRACT

Methods and systems for managing voicemail operations are provided here. In some embodiments a method for managing voicemail operations may include establishing a voicemail session with a voicemail system, transmitting message data over the voicemail session to be recorded in a voicemail message for a second user on the voicemail system, receiving an incoming call from a device associated with the second user while the voicemail session is active, and sending a first notification to the voicemail system to manage the voicemail message prior to establishing the incoming call with the device associated with the second user.

### BACKGROUND

1. Field

Embodiments of the present invention relate generally to communication systems and, more particularly, to methods and systems for managing voicemail operations in general, and more specifically, for managing voicemail operations in a Voice over Internet Protocol (VoIP) application.

2. Description of the Related Art

Voicemail systems are generally provided to users of most telecommunication service providers. Typically, when user A (the caller), calls user B (the callee), if the user B is not available or declines the call, user A is forwarded to a voicemail system and is given the option to leave a voice message to user B.

In many cases, while user A is recording a voicemail message, another call may come in to the phone of user A. If the telecommunication app being used to leave the message is an over-the-top (OTT) telecommunication app (e.g., a software application for a mobile device that is capable of providing communication services from a provider other than that typically associated with the portable electronic device), the phone operating system (OS) and native telephony services installed on the device may have priority to handle the incoming call, and relegate any OTT telecommunication app to the background. For example, user A is using a VoIP telecommunication app installed on user A's device to call user B and leave a message for user B. If an off-net call (e.g., a non-VoIP GSM call) to user A's device comes in while user A is leaving the message, the phone's OS notifies the VoIP telecommunication app that the application will be placed in the background and no more CPU time will be allocated to it until the GSM call is finished or acted upon by user A. As a result, the user A's voicemail call and associated message is placed on hold. Similarly, when new incoming on-net calls arrive while user A is leaving a message for user B, although the OTT telecommunication may not be placed in the background, the OTT telecommunication app may prioritize the new incoming call, and as a result, user A's voicemail call and associated message is placed on hold.

Typically, the voicemail system on the backend has a capability to detect silence. After a predefined period of silence is detected (e.g., 5-10 seconds), the voicemail system treats recording as done and the voicemail call will be terminated. When user A finishes the GSM call and tries to go back to the voicemail, the voicemail connection is gone, and the user cannot complete their voicemail message. Thus, in convention systems, the voicemail session is closed and user cannot resume the voicemail call. Moreover, the OTT telecommunication app is almost immediately put into the background when an off-net GSM call comes in. Therefore, the media path between OTT telecommunication app and voicemail system is cut off. As the result, the user has no chance to finish the voicemail recording.

In addition, in many cases, while user A is recording a voicemail message for user B, user B may see that user A called and attempt to call user A back. Typically, user A will then see that user B is calling and determine that they no longer need to leave a message and simply end the voicemail session and answer the incoming call from user B. As the result, the backend voicemail system delivers partially recorded message to user B. From both user A's and user B's perspective, there is no real need for voicemail system to deliver the partial voicemail since user B is talking with user A already. User B must needlessly login to their voicemail system to retrieve and dispose of the partial voicemail which is a waste of time and resources.

In view of the foregoing, there exists a need in the art for improved methods and systems for managing voicemail operations in a Voice over Internet Protocol (VoIP) application.

### SUMMARY

Methods and systems for managing voicemail operations are provided here. In some embodiments a method for managing voicemail operations may include establishing a voicemail session with a voicemail system, transmitting message data over the voicemail session to be recorded in a voicemail message for a second user on the voicemail system, receiving an incoming call from a device associated with the second user while the voicemail session is active, and sending a first notification to the voicemail system to manage the voicemail message prior to establishing the incoming call with the device associated with the second user.

In some embodiments, a method for managing voicemail operations may include accepting a request to establish a voicemail session with a first user device by transmitting a first signaling message to the first user device indicating that a call request from the first device directed to a called identifier associated with a second user failed, wherein the first signaling message includes voicemail status information indicating that the voicemail session is being established with a voicemail system, recording a voicemail message for the second user, receiving a first notification from the first user device, while recording the voicemail message, to delete the voicemail message, and delete the voicemail message.

In some embodiments, a system for managing voicemail operations may include a first telecommunication module configured to transmit message data over a voicemail session to be recorded in a voicemail message for a second user on a voicemail system, wherein the voicemail session is established with the voicemail system, receive an incoming call from a device associated with the second user while the voicemail session is active, and send a first notification to the voicemail system to manage the voicemail message prior to establishing the incoming call with the device associated with the second user.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a telecommunication network, according to one or more embodiments of the invention;

FIG. 2 depicts a block diagram of a system for managing voicemail operations, according to one or more embodiments;

FIGS. 3A and 3B depict a method for managing voicemail operations, according to one or more embodiments;

FIGS. 4A and 4B depicts a graphical user interface for a telecommunication application for managing voicemail operations, according to one or more embodiments;

FIGS. 5A and 5B depict a method for managing voicemail operations, according to one or more embodiments;

FIG. 6 depicts a method for deleting voicemail messages, according to one or more embodiments;

FIGS. 7A and 7B depict a another method for deleting voicemail messages, according to one or more embodiments;

FIG. 8 depicts a graphical user interface for a telecommunication application managing voicemail operations, according to one or more embodiments; and

FIG. 9 depicts a computer system that can be utilized in various embodiments of the present invention, according to one or more embodiments.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention relate generally to improved methods and systems for managing voicemail operations in a VoIP telecommunication application. More specifically, embodiments of the present invention provide users with the option to place a voicemail session and associated voicemail message recording on hold while another task (i.e., answering another call) is performed. Exemplary embodiments may keep the voicemail session active/open for a configurable period of time after receiving a hold indication from the user's device. This may be achieved by signal exchange between the VoIP telecommunication application and the backend voicemail system. The VoIP telecommunication application user will advantageously have the ability return to the voicemail session and complete or otherwise manage (e.g., delete) the voicemail message recording.

In addition, embodiments of the present invention provide users with the option to delete a partially recorded voicemail message recording when a new incoming call comes in while recording the message. This may be achieved by signal exchange between the VoIP telecommunication application and the backend voicemail system.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the following description, the terms VOIP system, VOIP telephony system, IP system and IP telephony system are all intended to refer to a system that connects callers and that delivers data, text and video communications using Internet protocol data communications. Those of ordinary skill in the art will recognize that embodiments of the present invention are not limited to use with IP telephony systems and may also be used in other systems.

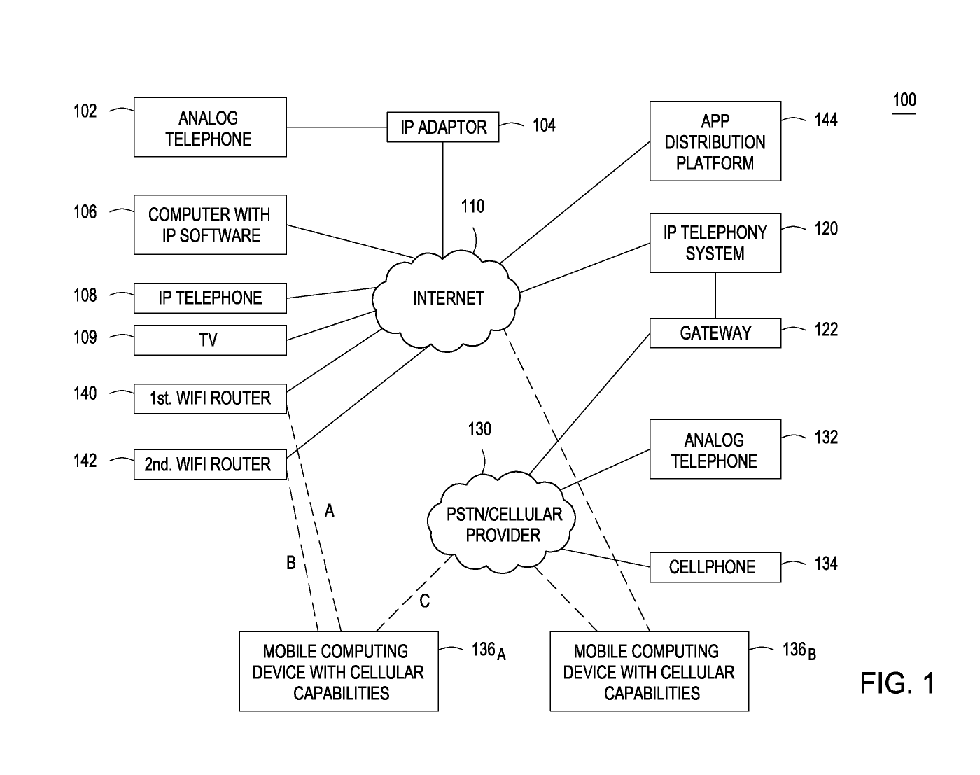

As illustrated in FIG. 1, a communications environment 100 is provided to facilitate IP enhanced communications. An IP telephony system 120 enables connection of telephone calls between its own customers and other parties via data communications that pass over a data network 110. The data network 110 is commonly the Internet, although the IP telephony system 120 may also make use of private data networks. The IP telephony system 120 is connected to the Internet 110. In addition, the IP telephony system 120 is connected to a publicly switched telephone network (PSTN) 130 via a gateway 122. The PSTN 130 may also be directly coupled to the Internet 110 through one of its own internal gateways (not shown). Thus, communications may pass back and forth between the IP telephony system 120 and the PSTN 130 through the Internet 110 via a gateway maintained within the PSTN 130.

The gateway 122 allows users and devices that are connected to the PSTN 130 to connect with users and devices that are reachable through the IP telephony system 120, and vice versa. In some instances, the gateway 122 would be a part of the IP telephony system 120. In other instances, the gateway 122 could be maintained by a third party.

Customers of the IP telephony system 120 can place and receive telephone calls using an IP telephone 108 that is connected to the Internet 110. Such an IP telephone 108 could be connected to an Internet service provider via a wired connection or via a wireless router. In some instances, the IP telephone 108 could utilize a packet-switched network of a cellular telephone system to access the Internet 110.

Alternatively, a customer could utilize an analog telephone 102 which is connected to the Internet 110 via a telephone adapter 104. The telephone adapter 104 converts analog signals from the telephone 102 into data signals that pass over the Internet 110, and vice versa. Analog telephone devices include but are not limited to standard telephones and document imaging devices such as facsimile machines. A configuration using a telephone adapter 104 is common where the analog telephone 102 is located in a residence or business. Other configurations are also possible where multiple analog telephones share access through the same IP adaptor. In those situations, all analog telephones could share the same telephone number, or multiple communication lines (e.g., additional telephone numbers) may provisioned by the IP telephony system 120.

In addition, a customer could utilize a soft-phone client running on a computer 106 or a television 109 to place and receive IP based telephone calls, and to access other IP telephony systems (not shown). The computer 106 may be a personal computer (PC), a tablet device, a gaming system, and the like. In some instances, the soft-phone client could be assigned its own telephone number. In other instances, the soft-phone client could be associated with a telephone number that is also assigned to an IP telephone 108, or to a telephone adaptor 104 that is connected one or more analog telephones 102.

users of the IP telephony system 120 are able to access the service from virtually any location where they can connect to the Internet 110. Thus, a customer could register with an IP telephony system provider in the U.S., and that customer could then use an IP telephone 108 located in a country outside the U.S. to access the services. Likewise, the customer could also utilize a computer outside the U.S. that is running a soft-phone client to access the IP telephony system 120.

A third party using an analog telephone 132 which is connected to the PSTN 130 may call a customer of the IP telephony system 120. In this instance, the call is initially connected from the analog telephone 132 to the PSTN 130, and then from the PSTN 130, through the gateway 122 to the IP telephony system 120. The IP telephony system 120 then routes the call to the customer's IP telephony device. A third party using a cellular telephone 134 could also place a call to an IP telephony system customer, and the connection would be established in a similar manner, although the first link would involve communications between the cellular telephone 134 and a cellular telephone network. For purposes of this explanation, the cellular telephone network is considered part of the PSTN 130.

In the following description, references will be made to an “IP telephony device.” This term is used to refer to any type of device which is capable of interacting with an IP telephony system to complete an audio or video telephone call or to send and receive text messages, and other forms of communications. An IP telephony device could be an IP telephone, a computer running IP telephony software, a telephone adapter which is itself connected to a normal analog telephone, or some other type of device capable of communicating via data packets. An IP telephony device could also be a cellular telephone or a portable computing device that runs a software application that enables the device to act as an IP telephone. Thus, a single device might be capable of operating as both a cellular telephone that can facilitate voice based session calls, and an IP telephone that can facilitate data based session calls.

The following description will also refer to a mobile telephony device. The term “mobile telephony device” is intended to encompass multiple different types of devices. In some instances, a mobile telephony device could be a cellular telephone. In other instances, a mobile telephony device may be a mobile computing device, such as the APPLE IPHONE, that includes both cellular telephone capabilities and a wireless data transceiver that can establish a wireless data connection to a data network. Such a mobile computing device could run appropriate application software to conduct VoIP telephone calls via a wireless data connection. Thus, a mobile computing device, such as an APPLE IPHONE, a RIM BLACKBERRY or a comparable device running GOOGLE ANDROID operating system could be a mobile telephony device.

In still other instances, a mobile telephony device may be a device that is not traditionally used as a telephony device, but which includes a wireless data transceiver that can establish a wireless data connection to a data network. Examples of such devices include the APPLE IPOD TOUCH and the IPAD. Such a device may act as a mobile telephony device once it is configured with appropriate application software.

FIG. 1 illustrates that a mobile computing device with cellular capabilities 136A (e.g., a smartphone) is capable of establishing a first wireless data connection A with a first wireless access point 140, such as a WiFi or WiMax router. The first wireless access point 140 is coupled to the Internet 110. Thus, the mobile computing device 136A can establish a VOIP telephone call with the IP telephony system 120 via a path through the Internet 110 and the first wireless access point 140.

FIG. 1 also illustrates that the mobile computing device 136A can establish a second wireless data connection B with a second wireless access point 142 that is also coupled to the Internet 110. Further, the mobile computing device 136A can establish either a third wireless data connection C via a packet-switch network provided by a cellular service provider 130 using its cellular telephone capabilities, or establish a voice based session telephone call via a circuit-switched network provided by a cellular service provider 130. The mobile computing device 136A could also establish a VoIP telephone call with the IP telephony system 120 via the second wireless connection B or the third wireless connection C.

Although not illustrated in FIG. 1, the mobile computing device 136A may be capable of establishing a wireless data connection to a data network, such as the Internet 110, via alternate means. For example, the mobile computing device 136A might link to some other type of wireless interface using an alternate communication protocol, such as the WIMAX standard. In the embodiments described above, a device may act as a mobile telephony device once it is configured with appropriate application software that may be downloaded from an app distribution platform 144. For example, mobile computing device 136A may download a VOIP mobile app from app distribution platform 144 and install the VOIP mobile app on mobile computing device 136A.

Similarly, mobile computing device with cellular capabilities 136B may also be coupled to internet 110 and/or cellular service provider 130. In some embodiments, mobile computing device 136B may be connected to internet 110 via a WIFI or WIMAX connection, and the like, and can also establish a VOIP telephone calls with the IP telephony system 120 similar to mobile computing device 136A. In embodiments of the present invention, communications environment 100 may be used to establish voice based or data based telecommunications sessions between mobile computing device 136A and mobile computing device 136B, depending on various criteria associated with each of the mobile computing devices, as will be described below in more detail. In some exemplary embodiments described below, mobile computing devices 136A and 136B are on different service provider networks and communications between mobile computing devices 136A and 136B are “off-net”communications. When mobile computing devices 136A and 136B are on the same service provider network, communications between mobile computing devices 136A and 136B are considered “on-net” communications.

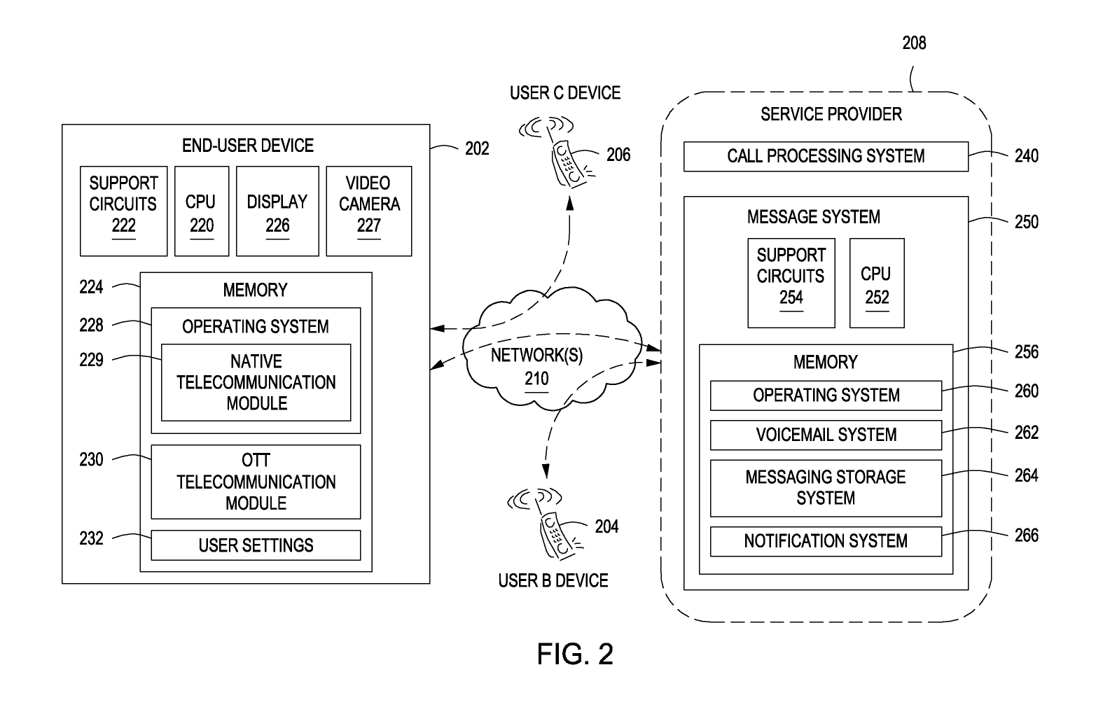

FIG. 2 depicts a block diagram of a system 200 for managing voicemail operations in accordance with embodiments presented herein. The system 200 includes at least one telecommunication service provider network 208 that can provide telecommunication services to a plurality of end-user devices (e.g., such as user A device 202 and user B device 204) via one or more networks 210. Devices 202 and 204 may include analog phone 102, a computer with IP software 106, IP telephone 108, and/or mobile computing device with cellular capabilities 136A, 136B, and the like, as shown in FIG. 1. The telecommunication service provider 208 may include IP telephone system 120 that facilitates on-net calls between user A device 202 and user B device 204. Also shown in FIG. 2, other user devices (e.g., user C device 206) may make off-net calls to user device A 202 using a different telecommunication service provider (e.g., a PSTN service provider).

The end-user devices (e.g., user A device 202 and user B device 204) comprise a Central Processing Unit (CPU) 220, support circuits 222, memory 224, display device 226, and video camera 227. The CPU 220 may comprise one or more commercially available microprocessors or microcontrollers that facilitate data processing and storage. The various support circuits 222 facilitate the operation of the CPU 220 and include one or more clock circuits, power supplies, cache, input/output circuits, and the like. The memory 224 comprises at least one of Read Only Memory (ROM), Random Access Memory (RAM), disk drive storage, optical storage, removable storage and/or the like. In some embodiments, the memory 224 comprises an operating system (OS) 228, an over-the-top (OTT) telecommunication module 230, and user settings 232. The OS 229 includes a native telecommunication module 229. The OTT telecommunication module 230 may be a VoIP mobile app provided by, or otherwise associated with, telecommunication service provider network 208. The OTT telecommunication module 230 may be downloaded from app distribution platform 144 and installed on user A device 202 and/or user B device 204.

The operating system (OS) 228 generally manages various computer resources (e.g., network resources, file processors, and/or the like). The operating system 228 is configured to execute operations on one or more hardware and/or software modules, such as Network Interface Cards (NICs), hard disks, virtualization layers, firewalls and/or the like. Examples of the operating system 228 may include, but are not limited to, LINUX, MAC OSX, BSD, UNIX, MICROSOFT WINDOWS, 10S, ANDROID and the like. As discussed above, the OS 228 also includes a native telecommunication module 229 that is designed to provide telecommunication services that are tightly coupled with the OS and provided by a native telecommunication service provider (e.g., a PSTN, GSM, CDMA 1x, WCDMA, 2G, 3G, LTE, etc. mobile telecommunication service provider).

The telecommunication service provider network 208 may be a VoIP service provider network and includes a call processing system 240 and a message system 250. In some embodiments, the message system 250 comprises a Central Processing Unit (CPU) 252, support circuits 254, and memory 256. The CPU 252 may comprise one or more commercially available microprocessors or microcontrollers that facilitate data processing and storage. The various support circuits 254 facilitate the operation of the CPU 252 and include one or more clock circuits, power supplies, cache, input/output circuits, and the like. The memory 256 comprises at least one of Read Only Memory (ROM), Random Access Memory (RAM), disk drive storage, optical storage, removable storage and/or the like. In some embodiments, the memory 256 comprises an operating system 260, voicemail system 262, message storage system 264, and notification system 266. In some embodiments, the components of the message system 250 (i.e., the voicemail system 262, message storage system 264, and notification system 266) may be disposed on a single server. In other embodiments, the voicemail system 262, message storage system 264, and notification system 266 may each be separate servers communicatively coupled to each other. In some embodiments, the voicemail system 262, message storage system 264, and notification system 266 may be co-located or may be distributed cloud based services maintained by different entities.

The OS 260 generally manages various computer resources (e.g., network resources, file processors, and/or the like). The operating system 260 is configured to execute operations on one or more hardware and/or software modules, such as Network Interface Cards (NICs), hard disks, virtualization layers, firewalls and/or the like. Examples of the operating system 260 may include, but are not limited to, LINUX, MAC OSX, BSD, UNIX, MICROSOFT WINDOWS, IOS, ANDROID and the like.

The networks 210 comprise one or more communication systems that connect computers by wire, cable, fiber optic and/or wireless link facilitated by various types of well-known network elements, such as hubs, switches, routers, and the like. The networks 210 may include an Internet Protocol (IP) network 110, a public switched telephone network (PSTN) 130, or other mobile communication networks listed above, and may employ various well-known protocols to communicate information amongst the network resources.

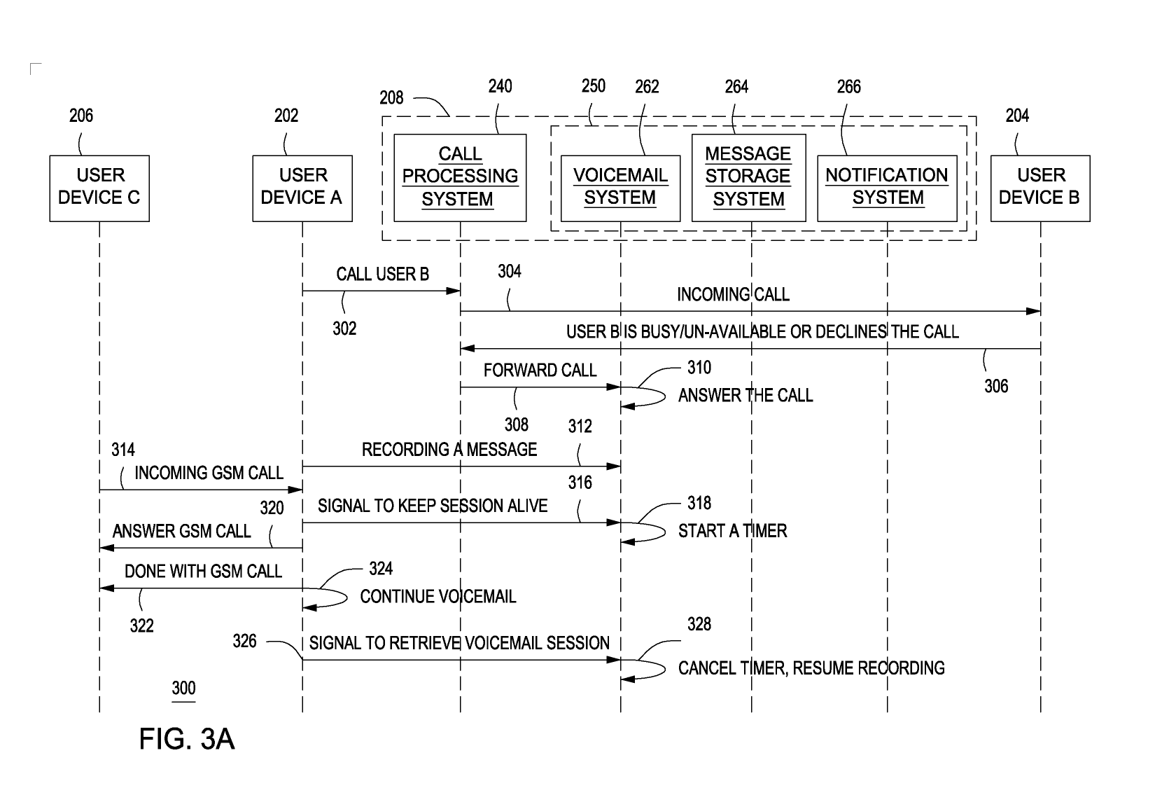

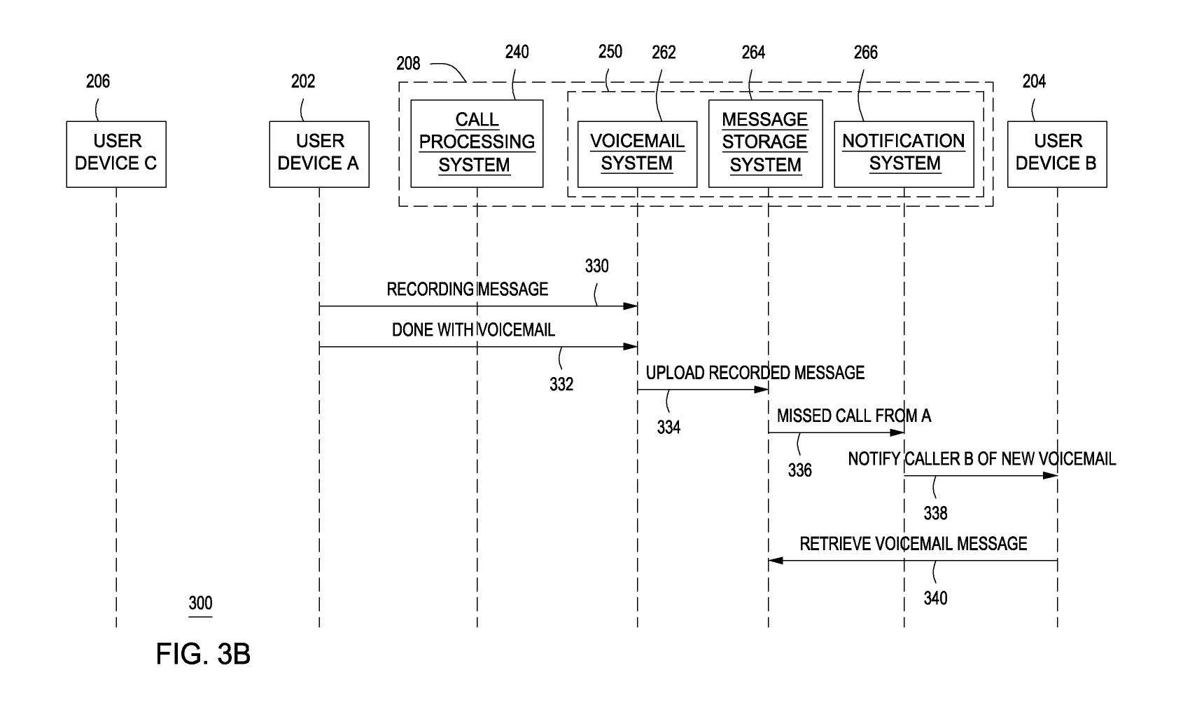

Referring to FIGS. 3A and 3B, a method 300 for managing voicemail operations begins at 302 where user A attempts to establish a call to user B. In some embodiments, the call request may be originated by a telecommunication device such as, for example, user A device 202 in FIG. 2. The call may be a voice call, or in some embodiments, the call may be a video call. In attempting to establish the call with user B, a call request is sent to call processing system 240 to be processed at step 302. In a VoIP network, the call request oftentimes takes the form of a Session Initiation Protocol (SIP) INVITE message sent from user A device 202 to a call processing system 240. In a VoIP network, the call processing system 240 may be, for example, a SIP Proxy Network. The details and functionality of SIP can be found in the Internet Engineering Task Force (IETF) Request for Comments (RFC) Paper No. 3261 entitled, “SIP: Session Initiation Protocol” herein incorporated in its entirety by reference.

Call processing system 240 attempts to establish a voice or video connection between user A device 202 and user B device 204 at step 304. To accomplish this, in some embodiments, call processing system 240 (e.g., a SIP Proxy Network) may send a SIP INVITE message to user B device 204. At 306, an indication is received by call processing system 240 that user B is busy, unavailable, or declines the call (i.e., the call went unanswered). At 308, the unanswered call is forwarded, or otherwise transferred, to voicemail system 262. For example, in some embodiments, call processing system 240 may forward the SIP INVITE message to voicemail system 262. In some embodiments, the SIP INVITE message may be forwarded to voicemail system 262 after explicit indication that user B declined that call, or after a specified timeout period indicating that the call went unanswered. It is generally understood in the art the forwarding a SIP INVITE, for example, may include generating and sending a new SIP INVITE message based on the received SIP INVITE message and not literally forwarding the exact message received. For example, in some embodiments, a different SIP Request Uniform Resource Identifier (URI) may be used that includes the same call-id for call tracking and additional custom SIP header for Voicemail System. In some embodiments a SIP REFER method may be used to forward/transfer the call to the voicemail system.

At 310, the voicemail system 262 “answers the call”, such that the telecommunication session is established between the user A device 202 and the voicemail system 262. In some embodiments, establishing the telecommunication session between the user A device 202 and the voicemail system 262 includes: (1) sending a first acknowledgement/call acceptance message in response to the forwarded call from the voicemail system 262 to the call processing system 240, and (2) sending a second acknowledgement/call acceptance message from the call processing system 240 to user A device 202, to establish the call between the user A device 202 and the voicemail system 262. In some embodiments, the first and second acknowledgement/call acceptance messages may include information in the header or the body of the message to inform user A device 202 that the call is being established with voicemail system 262. For example, in a VoIP system, the first and second acknowledgement/call acceptance messages may be SIP 200 OK messages. The SIP 200 OK messages may include a custom SIP header indicating that the call is being established with, or was otherwise forwarded to, voicemail system 262. In other embodiments, an existing field in the SIP message header or body may be used to convey that the call is being established with, or was otherwise forwarded to, voicemail system 262. In some embodiments, the telecommunication session established may be a real time transfer protocol (RTP) stream between telecommunication module 230 disposed on user A device 202 and the voicemail system 262. As discussed above, the telecommunication module 230 may be a mobile Internet protocol (IP) app, or other type of OTT telecommunications app, disposed on device 202.

After the telecommunication session is established between device 202 and voicemail system 262 at 310, user A may begin recording a voicemail message via device 202 to leave user B at 312. The voicemail message may be an audio voicemail message or a video message including video and audio.

While, leaving a voicemail message, user A device 202 may receive a new incoming call from user C device 206 at 314. In some embodiments, the new incoming call may be an off-net call or an on-net call. For example, in embodiments where user A device 202 is using a VoIP service provider to call user B and leave a voicemail for user B, the new incoming call may be an off-net cellular call from user C device 206 on a PSTN network. In other embodiments, where user A device 202 is using a VoIP service provider to call user B and leave a voicemail for user B, the new incoming call may be an on-net VoIP call from another device that is also using the same VoIP server provider (e.g., telecommunication service provider 208) as user A.

At 316, a notification/signal is sent by OTT telecommunication module 230 to the voicemail system 262 to keep the voicemail session alive and to pause the voicemail recording. In some embodiments, the notification to keep the voicemail session alive (i.e., place the voicemail session on hold) and pause the voicemail message is automatically sent by OTT telecommunication module 230 to the voicemail system 262 when new incoming call comes in at 314 to user A device 202. That is, prior to being placed in the background by OS 228, OTT telecommunication module 230 is given an opportunity to send the notification/signal to the messaging system 250 to which it is communicating with. Therefore, instead of automatically treating the recording as finished and terminating the voicemail call as done in conventional voicemail systems, embodiments consistent with the present invention will keep the voicemail session active and merely pause the recording to allow user A to return to the recording after the new incoming call has been completed, transferred, placed on hold, and the like.

In some embodiments, the signal/message may include a Dual-tone multi-frequency signaling (DTMF) tone (e.g., such as a DTMF-A, DTMF-B, DTMF-C, DTMF-D tone). Hidden DTMF tones are known to those skilled in the art as seen by the International Telecommunications Union document ITU-T Recommendation Q.23 entitled, “Technical Features of Push-Button Telephone Sets” (1993) and is herein incorporated by reference. In some embodiments, the DTMF tone may be generated from the telecommunication module 230 and sent over the RTP stream to the voicemail system 262. The voicemail system 262 detects the DTMF tone and processes the action accordingly. The various voicemail management tasks provided by the OTT telecommunication application 230 may each have a distinct DTMF tone associated with it such that the voicemail system 262 can detect the voicemail management task by the distinct DTMF tone. In other embodiments, the signal/message that indicates the voicemail management task may be one of a Session Initiation Protocol (SIP) message, an Extensible Messaging and Presence Protocol (XMPP) message, or a Hypertext Transfer Protocol (HTTP) message including the voicemail management task requested (e.g., in a standard or customer header or body field), or a voice command that is processed by speech recognition modules included in voicemail system 262.

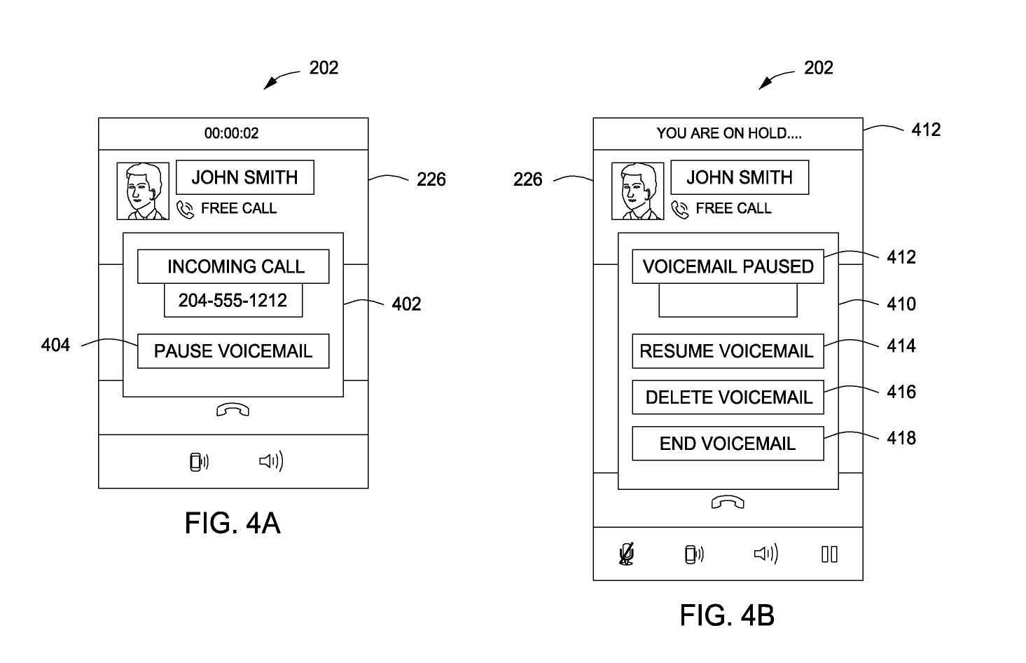

In alternative embodiments, the OS 228 may allow the OTT telecommunication module 230 to display options on display 226 for user A, so that user A may select how they wish to manage the incomplete voicemail message. In some embodiments, the options may be in the form of selectable display objects on the display 226 of device 202 within the OTT telecommunication module 230 as shown in FIG. 4A. FIG. 4A depicts a display box 402 that may automatically be displayed when a new incoming call arrives while leaving a message, or otherwise on a call with another device, using OTT telecommunication module 230. The display box 402 may include voicemail message management options such as, for example, a pause message option that is selectable via selectable display object 404. In embodiments consistent with FIG. 4A, the selection of the display object 404 sends a signal/message (i.e., a notification) to the voicemail system 262 that indicates that a message should be paused and the voicemail connection be placed on hold.

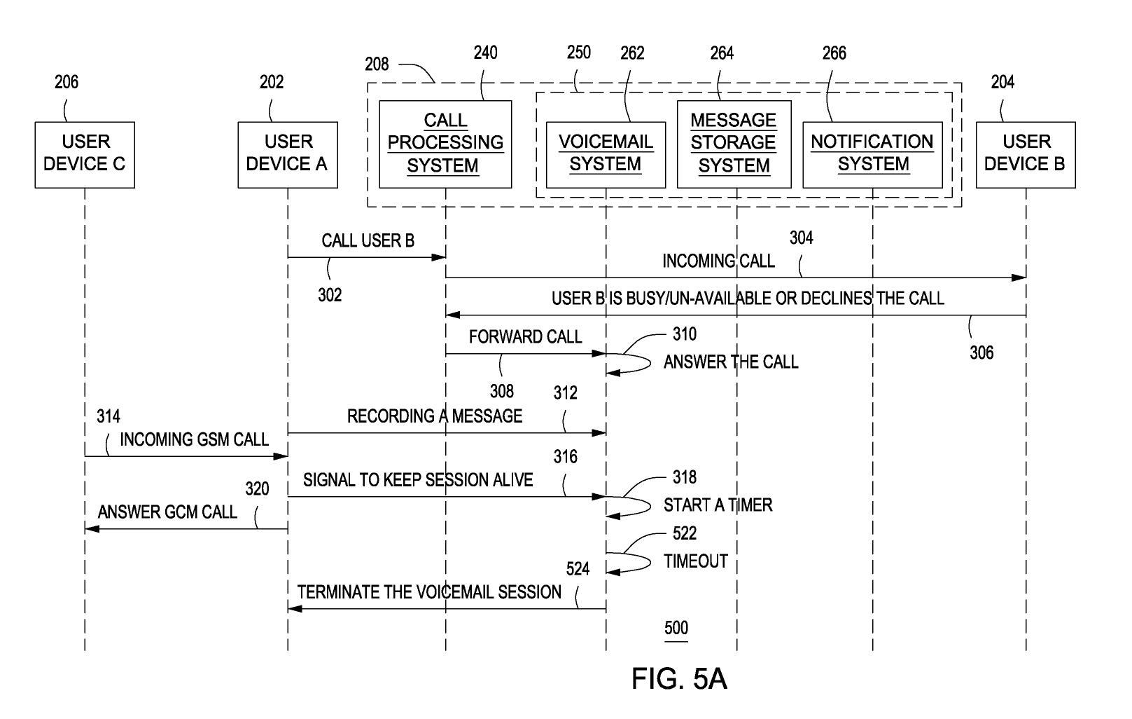

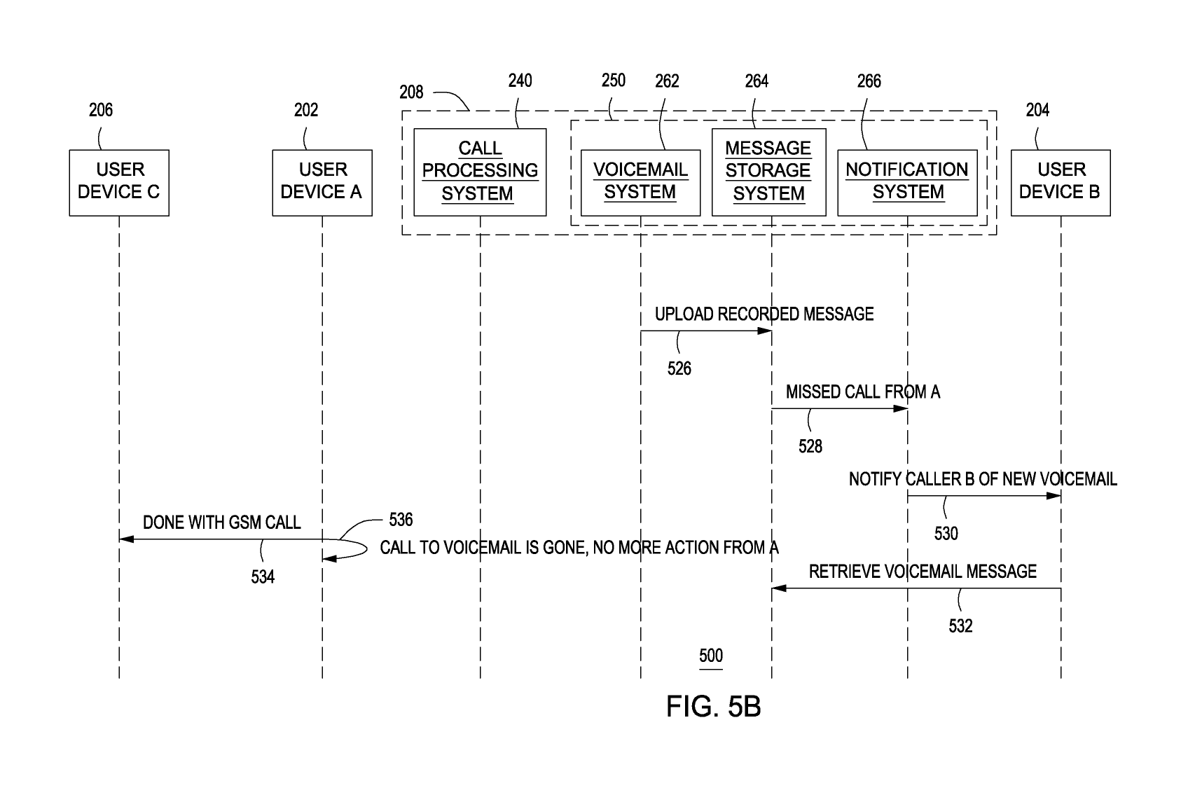

Returning to FIGS. 3A and 3B, when the pause message/signal (i.e., notification) is sent to the voicemail system 262 at 316, the voicemail system 262 will pause the recording of the voicemail message and place the voicemail session on hold. In some embodiments the voicemail system starts a timer at 318. Specifically, in some embodiments, the voicemail system will wait a configurable amount of time to allow the user to complete the voicemail message and to keep the voicemail session alive. If the user does not return prior to expiration of the time period, the method proceeds as shown in FIGS. 5A and 5B. The configuration period of time may be set by the service provider 208 and is a system wide setting to avoid abuse of the system and to prevent resources from being tied up too long. In some embodiments, the timeout period is in the range of about 60 seconds to about 3 minutes. In some embodiments, there may not be an actual timer—rather, the system may note the time the pause notification was received and calculate the timeout period based on that time.

At 320, user A answers the new incoming call and at 322 completes the call with user C device 206. At 324, user A returns to the OTT telecommunication application 230 to continue the voicemail message/session. In some embodiments, if user A returns to the OTT telecommunication application 230 prior to expiration of the timeout period, the OTT telecommunication application 230 will automatically un-hold the voicemail session and resume recording of the voicemail message.

In other embodiments, if user A returns to the OTT telecommunication application 230 prior to expiration of the timeout period, the OTT telecommunication application 230 will display options to proceed with the voicemail message/session. In some embodiments, the options may be in the form of selectable display objects on the display 226 of device 202 within the OTT telecommunication module 230 as shown in FIG. 4B. FIG. 4B depicts a display box 410 that may automatically be displayed when the user switches back to OTT telecommunication module 230. The display box 410 may include an indication 412 that the voicemail message is currently paused and voicemail message management options such as, for example, a resume message option that is selectable via selectable display object 414, a delete message option that is selectable via selectable display object 416, and an end voicemail option that is selectable via selectable display object 418.

At 326, a message/signal to resume recording of the voicemail message is sent to voicemail system 262. Specifically, in some embodiments, the OTT telecommunication application 230 will automatically un-hold the voicemail session and resume recording of the voicemail message when OTT telecommunication application 230 is brought to foreground operation on device 202.

In other embodiments, the selection of the display object 414 sends a signal/message (i.e., a notification) to the voicemail system 262 that indicates that the voicemail session is no longer on hold (i.e., un-hold the call to resume the session) and that the voicemail message recording should be resumed at 326. That is, in some embodiments consistent with the present invention, user A is able to signal the voicemail system 262 via user A device 202 to resume the voicemail message recording.

In other embodiments, a selection of selectable display object 416 to delete the voicemail message (e.g., user A presses display object 416) sends a signal/message (i.e., a notification) to the voicemail system 262 that indicates that the partial voicemail message should be deleted and the voicemail connection be terminated. Similarly, a selection of selectable display object 418 to end the voicemail message (e.g., user A presses display object 418) sends a signal/message (i.e., a notification) to the voicemail system 262 that indicates that the partial voicemail message recording should be treated as complete and the voicemail connection be terminated. The signal/message may be DTMF tones or SIP messages as described above.

Returning to FIGS. 3A and 3B, when the selection of the resume option is received by the device 202 at 326, the voicemail system 262 will cancel the timer and allow the user to resume recording of the voicemail message at 328. User A resumes recording the voicemail message at 330 and completes the voicemail at 332. At 334, the voicemail system 262 uploads the completed voicemail to message storage system 264 of the message system 250. Upon receiving the uploaded voicemail message, the message storage system 264 will store the voicemail message in a mailbox associated with user B.

In some embodiments, the voicemail message may be two or more separate audio/video files. Specifically, a first audio/video file may be created that includes the user's recording up until the signal at 316 is received to pause the recording. That is, in some embodiments, pausing the recording at 316 may close the audio/video file associated with the first part of the voicemail message, and resuming the recording may create a second audio/video file. The two audio/video files may be merged to create a single audio/video file, or the two files may be both uploaded and stored in message storage system 264, and linked such that they are played sequentially to user B upon retrieval. The audio/video files may be stored in any standard audio/video format, such as, for example, WAV, MP3, MPEG, AVI, and the like.

At 336, the message storage system 264 provides information associated with the voicemail message to notification system 266. At 338, the notification system 266 will send a notification to user B device 204 indicating that a voicemail message has been left for user B. At 340, user B may retrieve the voicemail message using the notification sent.

FIGS. 5A and 5B depict a method 500 for managing voicemail operations where a timeout period has expired. The method 500 begins at 302 and proceeds to 320 as described above with respect to FIGS. 3A and 3B. However, in embodiments consistent with FIGS. 5A and 5B, the configuration timeout period expires at 522. At 524, the voicemail system 262 terminates the voicemail session and uploads the partially recorded message at 526 to message storage system 264 of the message system 250. Upon receiving the uploaded voicemail message, the message storage system 264 will store the voicemail message in a mailbox associated with user B. At 528, the message storage system 264 provides information associated with the voicemail message to notification system 266. At 530, the notification system 266 will send a notification to user B device 204 indicating that a voicemail message has been left for user B. At 532, user B may retrieve the voicemail message using the notification sent.

At 534, user A may finish with the new incoming call and return to the OTT telecommunication application 230 at 536. However, since the timeout period expired at 522 and the voicemail session was terminated at 524, user A is no longer able to resume the voicemail session. The OTT telecommunication may display a notification that the voicemail session was terminated.

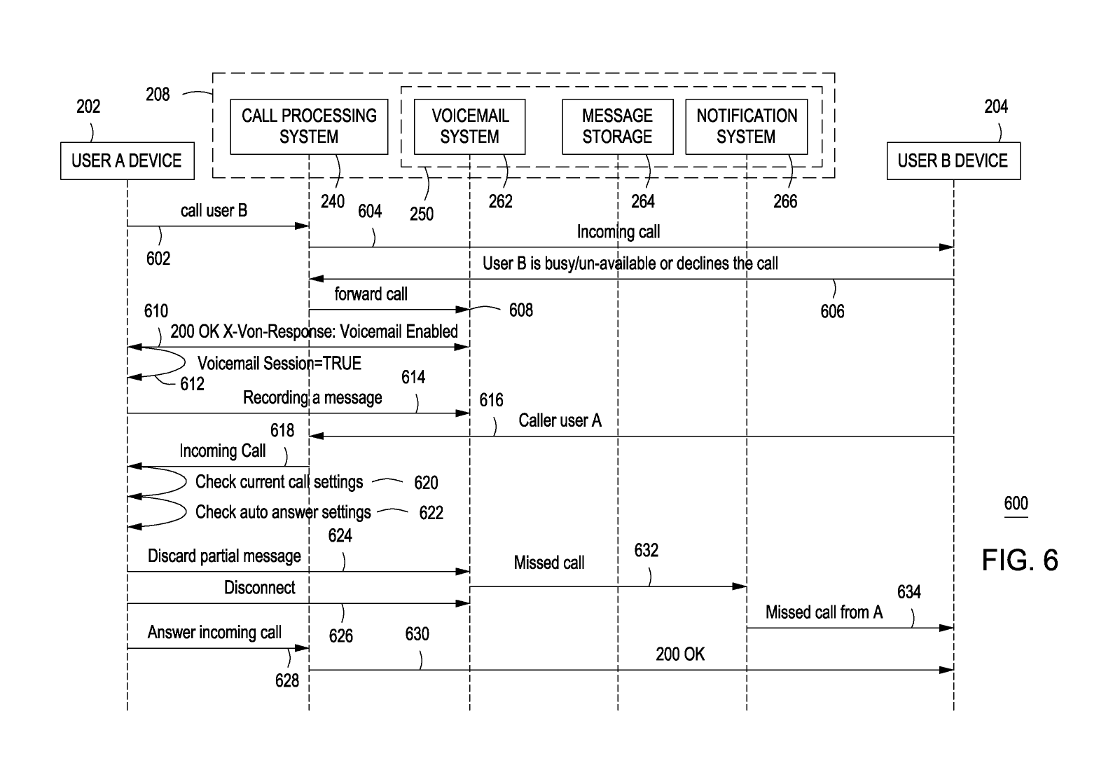

Referring to FIG. 6, a method 600 for deleting voicemail message when a new incoming call arrives begins at 602 where user A attempts to establish a call to user B. In some embodiments, the call request may be originated by a telecommunication device such as, for example, user A device 202 in FIG. 2. The call may be a voice call, or in some embodiments, the call may be a video call. In attempting to establish the call with user B, a call request directed to a called identifier (e.g., a phone number or a system-wide unique identifier) associated with user B is sent to call processing system 240 to be processed at step 602. In a VoIP network, the call request oftentimes takes the form of a SIP INVITE message sent from user A device 202 to a call processing system 240. In a VoIP network, the call processing system 240 may be, for example, a SIP Proxy Network.

Call processing system 240 attempts to establish a voice or video connection between user A device 202 and user B device 204 at step 604. To accomplish this, in some embodiments, call processing system 240 (e.g., a SIP Proxy Network) may send a SIP INVITE message to user B device 204. At 606, an indication is received by call processing system 240 that user B is busy, unavailable, or declines the call (i.e., the call went unanswered). At 608, the unanswered call is forwarded, or otherwise transferred, to voicemail system 262. For example, in some embodiments, call processing system 240 may forward the SIP INVITE message to voicemail system 262. In some embodiments, the SIP INVITE message may be forwarded to voicemail system 262 after explicit indication that user B declined that call, or after a specified timeout period indicating that the call went unanswered. It is generally understood in the art the forwarding a SIP INVITE, for example, may include generating and sending a new SIP INVITE message based on the received SIP INVITE message and not literally forwarding the exact message received. For example, in some embodiments, a different SIP Request Uniform Resource Identifier (URI) may be used that includes the same call-id for call tracking and additional custom SIP header for Voicemail System.

At 610, the voicemail system 262 “answers the call”, such that the telecommunication session is established between the user A device 202 and the voicemail system 262. In some embodiments, establishing the telecommunication session between the user A device 202 and the voicemail system 262 includes: (1) sending a first acknowledgement/call acceptance message in response to the forwarded call from the voicemail system 262 to the call processing system 240, and (2) sending a second acknowledgement/call acceptance message from the call processing system 240 to user A device 202, to establish the call between the user A device 202 and the voicemail system 262. In some embodiments, the first and second acknowledgement/call acceptance messages may include voicemail status information in the header or the body of the message to inform user A device 202 that the call is being established with voicemail system 262. For example, in a VoIP system, the first and second acknowledgement/call acceptance messages may be SIP 200 OK messages. The SIP 200 OK messages may include a custom SIP header including voicemail status information indicating that the call is being established with, or was otherwise forwarded to, voicemail system 262 (i.e., that the call is a voicemail session call). In other embodiments, an existing field in the SIP message header or body may be used to store the voicemail status information or otherwise convey that the call is being established with a voicemail system 262. In some embodiments, the telecommunication session established may be a real time transfer protocol (RTP) stream between telecommunication module 230 disposed on user A device 202 and the voicemail system 262. As discussed above, the OTT telecommunication module 230 may be a mobile Internet protocol (IP) app, or other type of OTT telecommunications app, disposed on device 202.

In some embodiments, at 612, OTT telecommunication module 230 may extract the voicemail status information and mark that the call is a voicemail session call. After the telecommunication session is established between device 202 and voicemail system 262 at 610, user A may begin recording a voicemail message via device 202 to leave user B at 614. The voicemail message may be an audio voicemail message or a video message including video and audio. The OTT telecommunication module 230 may provide the user an option to leave either an audio or video voicemail message.

While, leaving a voicemail message, user B may notice that user A called and try to establish a call with user A at 616 and 618 via service provider 208. User A device 202 may receive the new incoming call from user B device 204 at 618 while user A is recording a message for user B. Although described here as on-net calls (i.e., user A device, user B device, and the messaging system 250 all part of or using the same service provider 208), in some embodiments, the new incoming call may be an off-net call (i.e., a GSM call from user B not user the same service provider as user A).

At 620, the current call settings are checked. That is, the OTT telecommunications module 230 determines whether the current call is a voicemail session (i.e., checks the voicemail status information), and/or whether the incoming call is from the same user that user A is leaving a voicemail message for. Specifically, if the OTT telecommunication module 230 determines that user A is not on an active voicemail session, or that the incoming call is not from user B, the OTT telecommunication module 230 may end the voicemail message and disconnect the voicemail call. If, however, the OTT telecommunication module 230 determines that user A is currently on an active voicemail session leaving a message for user B, and the incoming call is from user B, the OTT telecommunications module 230 will then check the auto answer callback setting at 622, as shown in FIG. 6. In some embodiments, the determination of whether the incoming call is from the same user for which a message is being left is performed by comparing the called identifier from the voicemail session (i.e., the original phone number user A used to attempt to reach user B), and the incoming call identifier. If the called identifier from the voicemail session and the incoming call identifier are same, the system determines the current call is a callback from user B. User A and/or user B could be identified by a phone number or system-wide identifier assigned to them by the service provider network. In other embodiments, the determination may be performed by comparing the incoming call identifier with user A's address book entries. If the address book comparison indicates that the incoming call identifier is associated with user B, the OTT telecommunications module 230 will determine that the incoming call is from user B—even if the original phone number user A used to attempt to reach user B is different than the incoming call identifier of user B.

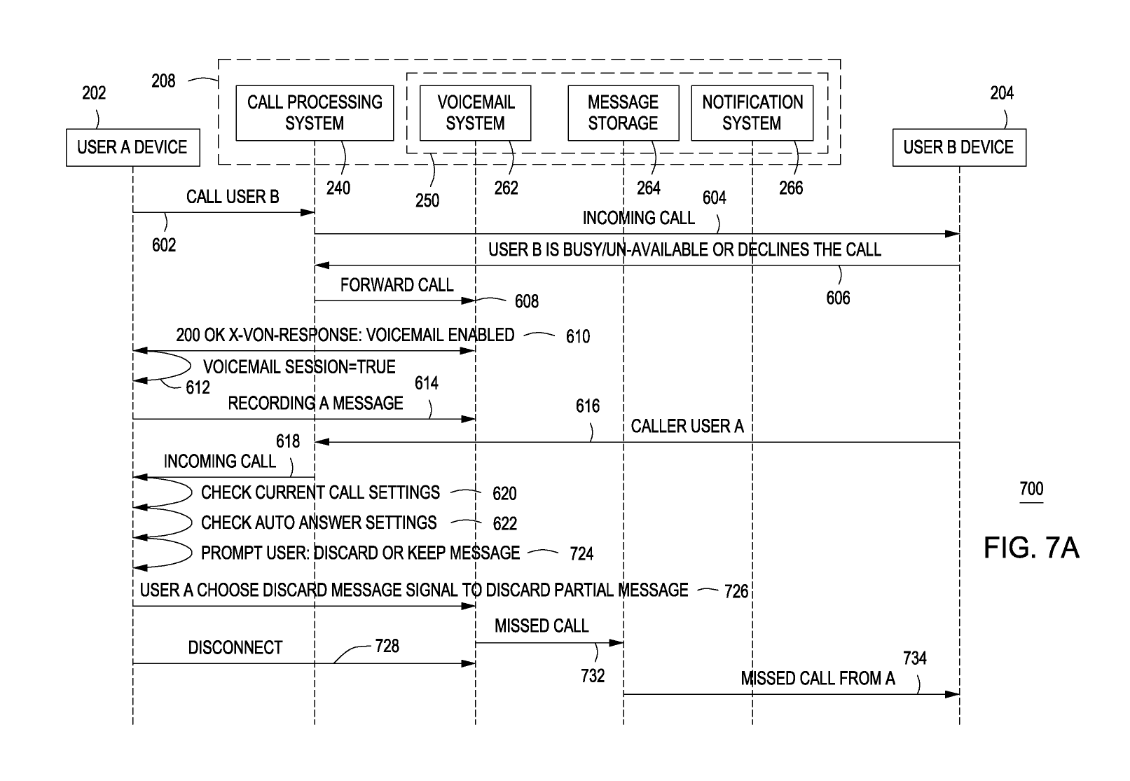

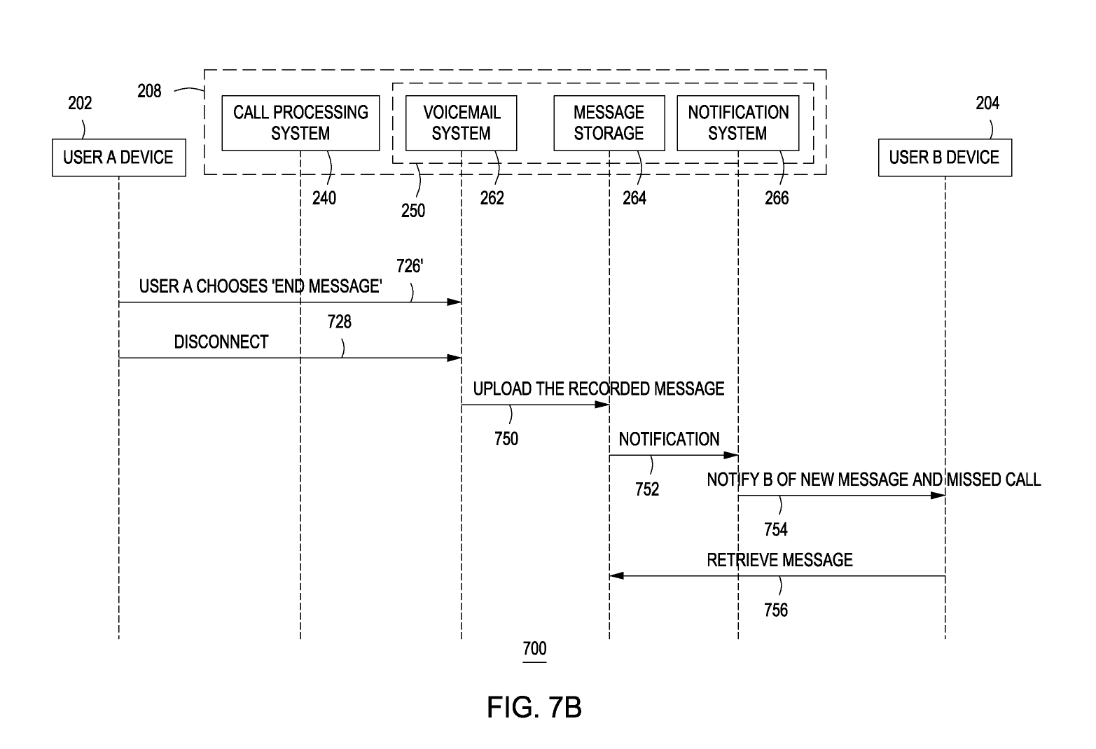

In some embodiments, the auto answer callback setting is stored in user settings 232. The auto answer callback setting can be set to “enabled” or “disabled” and is configurable by the user. If the auto answer callback setting is set to enabled, the partially recorded voicemail message will automatically be discarded in the voicemail session disconnected without any user interaction as will be described below in further detail with respect to FIG. 6. If the auto answer callback setting is disabled, the OTT telecommunication module 230 will display voicemail management options on user device 202 to allow the user to select how they would like to manage the partial voicemail message as described below in further detail with respect to FIGS. 7A and 7B.

Returning to FIG. 6, the OTT telecommunication module 230 determines that the auto answer callback setting is enabled at 622, and proceeds to 624. At 624, a notification/signal is sent by OTT telecommunication module 230 to the voicemail system 262 to discard the voicemail message and disconnect the voicemail session and 626. In some embodiments, the notification/signal is sent by OTT telecommunication module 230 to the voicemail system 262 to discard the voicemail message and disconnect the voicemail session may be two separate notifications/signals as shown in FIG. 6 (e.g., a special DTMF tone to discard voicemail message followed by regular SIP BYE message to disconnect the voicemail session). In other embodiments, a single notification/signal may be sent, that causes the voicemail mail to be discarded and the voicemail session to be disconnected (e.g., a SIP BYE message including “x-voicemail: Discard” in a special header). In some embodiments, the notification to discard the voicemail message and disconnect the voicemail session is automatically (i.e., without any user input) sent by OTT telecommunication module 230 to the voicemail system 262 when new incoming call comes in at 618 to user A device 202. Therefore, instead of automatically treating the recording as finished, uploading the partially recorded voicemail message to message storage 264, and terminating the voicemail call as done in conventional voicemail systems, embodiments consistent with the present invention will automatically discard the partially voicemail message.

In some embodiments, the signal/message may include a DTMF tone as described above with respect to FIGS. 3A and 3B. In other embodiments, the signal/message that indicates the voicemail management task may be one of a SIP message, an Extensible Messaging and Presence Protocol (XMPP) message, or a Hypertext Transfer Protocol (HTTP) message including the voicemail management task requested (e.g., in a standard or customer header or body field), or a voice command that is processed by speech recognition modules included in voicemail system 262.

When the voicemail system 262 receives the notification/signal to discard the voicemail message and disconnect the voicemail session at 624/626, the voicemail system 262 will delete the partially recorded message and disconnect the voicemail session. At 628, user A answers the incoming call from user B. In some embodiments, answering the incoming call includes sending an acknowledgment message (e.g., an SIP 200 OK message) to call processing system 240 at 628, and sending an acknowledgment message (e.g., an SIP 200 OK message) from call processing system 242 user B device 204 to establish a call between user A device and user B device.

In some embodiments, when the voicemail system 262 receives the signal/message to discard the voicemail message at 624, the voicemail system 262 may send a call notification to notification system 266 at 632, which in turn sends a call notification to user B device 204 at 634. In some embodiments, the call notification sent to user B device 204 may not show up as a missed call notification on user B's device, but rather as a call in a call history log.

With respect to FIGS. 7A and 7B, if at 622 the OTT telecommunication module 230 determines that the auto answer callback setting is disabled, the OTT telecommunication module 230 will display voicemail management options at 724 on user device 202 to allow the user to select how they would like to manage the partial voicemail message.

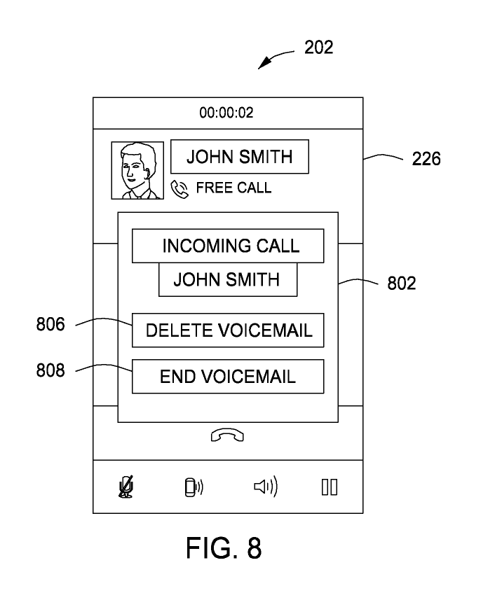

In some embodiments, the options may be in the form of selectable display objects on the display 226 of device 202 within the OTT telecommunication module 230 as shown in FIG. 8. FIG. 8 depicts a display box 802 that may automatically be displayed when a new incoming call arrives while leaving a message, or otherwise on a call with another device, using OTT telecommunication module 230. The display box 802 may include voicemail message management options such as, for example, a delete voicemail option that is selectable via selectable display object 806, and an end voicemail option that is selectable via selectable display object 808.

In embodiments consistent with FIG. 8, a selection of selectable display object 806 to delete the voicemail message (e.g., user A presses display object 806) sends a signal/message (i.e., a notification) to the voicemail system 262 that indicates that the partial voicemail message should be deleted and the voicemail connection be terminated at 726. Thus, the time and resources for leaving/retrieving/reporting/deleting the unnecessary message left for user are not wasted. At 728, the voicemail session is disconnected and user A may switch to the incoming call with user B as described above and 628 and 630 a FIG. 6.

In some embodiments, when the voicemail system 262 receives the signal/message to discard the voicemail message at 726, the voicemail system 262 may send a call notification to notification system 266 at 732, which in turn sends a call notification to user B device 204 at 734. In some embodiments, the call notification sent to user B device 204 may not show up as a missed call notification on user B's device, but rather as a call in a call history log.

In further embodiments consistent with FIG. 8, a selection of selectable display object 808 to end the voicemail message (e.g., user A presses display object 808) sends a signal/message (i.e., a notification) to the voicemail system 262 that indicates that the partial voicemail message recording should be treated as complete and the voicemail connection be terminated. At 750, the voicemail system 262 uploads the voicemail message to message storage system 264 of the message system 250. Upon receiving the uploaded voicemail message, the message storage system 264 will store the voicemail message in a mailbox associated with user B.

At 752, the message storage system 264 provides information associated with the voicemail message to notification system 266. At 754, the notification system 266 will send a notification to user B device 204 indicating that a voicemail message has been left for user B. At 756, user B may retrieve the voicemail message using the notification sent.

The embodiments of the present invention may be embodied as methods, apparatus, electronic devices, and/or computer program products. Accordingly, the embodiments of the present invention may be embodied in hardware and/or in software (including firmware, resident software, micro-code, and the like), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a non exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

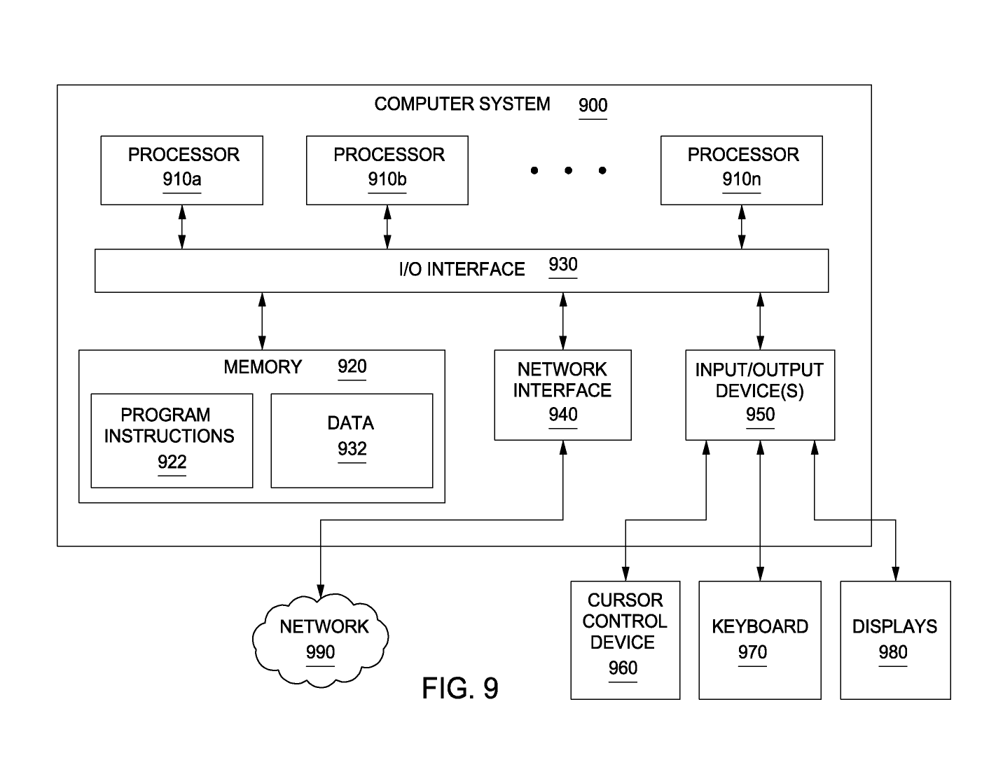

FIG. 9 depicts a computer system 900 that can be utilized in various embodiments of the present invention to implement the computer and/or the display, according to one or more embodiments.

Various embodiments of method and apparatus for routing calls based upon internal network conditions and/or external carrier network information, as described herein, may be executed on one or more computer systems, which may interact with various other devices. One such computer system is computer system 900 illustrated by FIG. 9, which may in various embodiments implement any of the elements or functionality illustrated in FIGS. 1-8. In various embodiments, computer system 900 may be configured to implement methods described above. The computer system 900 may be used to implement any other system, device, element, functionality or method of the above-described embodiments. In the illustrated embodiments, computer system 900 may be configured to implement methods 300, 500, 600 and 700 as processor-executable executable program instructions 922 (e.g., program instructions executable by processor(s) 910) in various embodiments.

In the illustrated embodiment, computer system 900 includes one or more processors 910a-910n coupled to a system memory 920 via an input/output (I/O) interface 930. Computer system 900 further includes a network interface 940 coupled to I/O interface 930, and one or more input/output devices 950, such as cursor control device 960, keyboard 970, and display(s) 980. In various embodiments, any of the components may be utilized by the system to receive user input described above. In various embodiments, a user interface may be generated and displayed on display 980. In some cases, it is contemplated that embodiments may be implemented using a single instance of computer system 900, while in other embodiments multiple such systems, or multiple nodes making up computer system 900, may be configured to host different portions or instances of various embodiments. For example, in one embodiment some elements may be implemented via one or more nodes of computer system 900 that are distinct from those nodes implementing other elements. In another example, multiple nodes may implement computer system 900 in a distributed manner.

In different embodiments, computer system 900 may be any of various types of devices, including, but not limited to, personal computer systems, mainframe computer systems, handheld computers, workstations, network computers, application servers, storage devices, a peripheral devices such as a switch, modem, router, or in general any type of computing or electronic device.

In various embodiments, computer system 900 may be a uniprocessor system including one processor 910, or a multiprocessor system including several processors 910 (e.g., two, four, eight, or another suitable number). Processors 910 may be any suitable processor capable of executing instructions. For example, in various embodiments processors 910 may be general-purpose or embedded processors implementing any of a variety of instruction set architectures (ISAs). In multiprocessor systems, each of processors 910 may commonly, but not necessarily, implement the same ISA.

System memory 920 may be configured to store program instructions 922 and/or data 932 accessible by processor 910. In various embodiments, system memory 920 may be implemented using any suitable memory technology, such as static random access memory (SRAM), synchronous dynamic RAM (SDRAM), non-volatile/Flash-type memory, or any other type of memory. In the illustrated embodiment, program instructions and data implementing any of the elements of the embodiments described above may be stored within system memory 920. In other embodiments, program instructions and/or data may be received, sent or stored upon different types of computer-accessible media or on similar media separate from system memory 920 or computer system 900.

In one embodiment, I/O interface 930 may be configured to coordinate I/O traffic between processor 910, system memory 920, and any peripheral devices in the device, including network interface 940 or other peripheral interfaces, such as input/output devices 950. In some embodiments, I/O interface 930 may perform any necessary protocol, timing or other data transformations to convert data signals from one component (e.g., system memory 920) into a format suitable for use by another component (e.g., processor 910). In some embodiments, I/O interface 930 may include support for devices attached through various types of peripheral buses, such as a variant of the Peripheral Component Interconnect (PCI) bus standard or the Universal Serial Bus (USB) standard, for example. In some embodiments, the function of I/O interface 930 may be split into two or more separate components, such as a north bridge and a south bridge, for example. Also, in some embodiments some or all of the functionality of I/O interface 930, such as an interface to system memory 920, may be incorporated directly into processor 910.

Network interface 940 may be configured to allow data to be exchanged between computer system 900 and other devices attached to a network (e.g., network 990), such as one or more external systems or between nodes of computer system 900. In various embodiments, network 990 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 940 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 950 may, in some embodiments, include one or more display terminals, keyboards, keypads, touchpads, scanning devices, voice or optical recognition devices, or any other devices suitable for entering or accessing data by one or more computer systems 900. Multiple input/output devices 950 may be present in computer system 900 or may be distributed on various nodes of computer system 900. In some embodiments, similar input/output devices may be separate from computer system 900 and may interact with one or more nodes of computer system 900 through a wired or wireless connection, such as over network interface 940.

In some embodiments, the illustrated computer system may implement any of the methods described above, such as the methods illustrated in FIGS. 3A/B, 5, 6 and 7A/B. In other embodiments, different elements and data may be included.

Those skilled in the art will appreciate that computer system 900 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 900 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 900 may be transmitted to computer system 900 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer-implemented method for managing voicemail operations, comprising:
establishing a voicemail session with a voicemail system;
transmitting message data over the voicemail session to be recorded in a voicemail message for a second user on the voicemail system;
receiving an incoming call from a device associated with the second user while the voicemail session is active; and
sending a first notification to the voicemail system to manage the voicemail message prior to establishing the incoming call with the device associated with the second user.

2. The computer-implemented method of claim 1, wherein voicemail session is established in response to a first signaling message received from the voicemail system indicating that a call request from a first device directed to a called identifier associated with the second user failed.

3. The computer-implemented method of claim 2, wherein receiving the incoming call includes determining that the incoming call from a device associated with the second user, and wherein determining that the incoming call is from a device associated with the second user includes comparing an incoming caller identifier of the incoming call with the called identifier associated with the second user.

4. The computer-implemented method of claim 2, wherein the first signaling message includes voicemail status information indicating that the voicemail session is being established with the voicemail system.

5. The computer-implemented method of claim 1, wherein the first notification to the voicemail system is sent automatically and without user input when the incoming call is received.

6. The computer-implemented method of claim 5, wherein the first notification to manage the voicemail message instructs the voicemail system to delete the voicemail message.

7. The computer-implemented method of claim 6, wherein the first notification further disconnects the voicemail session.

8. The computer-implemented method of claim 1, wherein one or more options to manage the voicemail message are displayed when the incoming call is received.

9. The computer-implemented method of claim 8, wherein the one or more options include a delete message option.

10. The computer-implemented method of claim 9, further comprising:
receiving a selection of the delete message option displayed; and
sending the first notification to the voicemail system to delete the recording of the voicemail message in response to the selection of the delete message option.

11. The computer-implemented method of claim 9, wherein the one or more options further include an end message option.

12. The computer-implemented method of claim 1, wherein the voicemail session is established using a Voice over Internet Protocol (VoIP) telecommunication application disposed on a first user device.

13. The computer-implemented method of claim 12, wherein the voicemail system and the VoIP telecommunication application are associated with the same VoIP service provider.

14. The computer-implemented method of claim 1, wherein the first notification is one of a Session Initiation Protocol (SIP) message, an Extensible Messaging and Presence Protocol (XMPP) message, or a Hypertext Transfer Protocol (HTTP) message.

15. The computer-implemented method of claim 1, wherein first notification sent is a Dual-tone multi-frequency signaling (DTMF) tone.

16. The computer-implemented method of claim 1, wherein the established voicemail session is a real time transfer protocol (RTP) stream.

17. The computer-implemented method of claim 1, wherein the voicemail message is one of an audio message or a video message.

18. A computer-implemented method for managing voicemail operations, comprising:
accepting a request to establish a voicemail session with a first user device by transmitting a first signaling message to the first user device indicating that a call request from the first device directed to a called identifier associated with a second user failed, wherein the first signaling message includes voicemail status information indicating that the voicemail session is being established with a voicemail system;
recording a voicemail message for the second user;
receiving a first notification from the first user device, while recording the voicemail message, to delete the voicemail message; and
deleting the voicemail message.

19. The computer-implemented method of claim 18, wherein the first notification is one of a Session Initiation Protocol (SIP) message, an Extensible Messaging and Presence Protocol (XMPP) message, or a Hypertext Transfer Protocol (HTTP) message.

20. The computer-implemented method of claim 18, wherein first notification sent is a Dual-tone multi-frequency signaling (DTMF) tone.

21. The computer-implemented method of claim 18, wherein the voicemail message is one of an audio message or a video message.

22. A system for managing voicemail operations, comprising:
a first telecommunication module configured to:
transmit message data over a voicemail session to be recorded in a voicemail message for a second user on a voicemail system, wherein the voicemail session is established with the voicemail system;
receive an incoming call from a device associated with the second user while the voicemail session is active; and
send a first notification to the voicemail system to manage the voicemail message prior to establishing the incoming call with the device associated with the second user.

23. The system of claim 22, wherein voicemail session is established in response to a first signaling message received from the voicemail system indicating that a call request from a first user device directed to a called identifier associated with the second user failed.

24. The system of claim 23, wherein the first telecommunication module is further configured to determine that the incoming call is from a device associated with the second user by comparing an incoming caller identifier of the incoming call with the called identifier associated with the second user.

25. The system of claim 23, wherein the first signaling message includes voicemail status information indicating that the voicemail session is being established with the voicemail system.

26. The system of claim 22, wherein the first notification to the voicemail system is sent automatically and without user input when the incoming call is received.
